(19) United States
(12) Patent Application Publication
(10) Pub. No.: US 2021/0056794 A1
(43) Pub. Date: Feb. 25, 2021

(54) MONEY HANDLING APPARATUS

(71) Applicant: Glory Ltd., Himeji-shi (JP)

(72) Inventors: Tasuku NAKAMOTO, Himeji-shi (JP); Keiju NAKAGAWA, Himeji-shi (JP); Masahito KAWAGUCHI, Himeji-shi (JP); Lin DIAO, Himeji-shi (JP); Yang CHEN, Himeji-shi (JP)

(73) Assignee: Glory Ltd., Himeji-shi (JP)

(21) Appl. No.: 16/996,915

(22) Filed: Aug. 19, 2020

(30) Foreign Application Priority Data
Aug. 23, 2019 (JP) 2019-153198

(51) Int. Cl. G07D 1/00; G07D 11/20; G07D 11/60

(52) U.S. Cl. CPC G07D 1/00; G07D 2201/00; G07D 11/60; G07D 11/20

(57) ABSTRACT

A money handling apparatus configured to dispense money includes: a container removably mounted to the apparatus and configured to store money of a plurality of denominations; a plurality of storing units configured to store money to be dispensed, for each denomination; a memory configured to store information on a threshold of a money storage quantity wherein the threshold is set for each denomination; and a control unit configured to perform control to monitor storage quantities of money for each denomination stored in the storing units, and to perform a replenishment process if a denomination of which the storage quantity becomes less than the threshold is detected, wherein in the replenishment process, money is fed out from the container, and at least one storing unit corresponding to the detected denomination is replenished with the money of the detected denomination among the fed out money.

### CROSS-REFERENCE TO RELATED APPLICATION

The present application claims priority to JP 2019-153198, filed Aug. 23, 2019, the entire contents of which are incorporated herein by reference.

### BACKGROUND OF THE INVENTION

### Field of the Invention

The present invention relates to a money handling apparatus which handles money.

### Description of the Background Art

Conventionally, money handling apparatuses each including a cassette removably mounted thereto have been used. For example, the cassette is used for replenishing the money handling apparatus with money. In a replenishment process, money fed out from the mounted cassette is stored in a storing unit which is provided in the money handling apparatus for storing money.

The money handling apparatus performs a depositing process to store deposited money in the storing unit. The money handling apparatus performs a dispensing process using the money stored in the storing unit. In the dispensing process, money to be dispensed according to an instruction by a user is fed out from the storing unit and discharged to the outside of the apparatus. When money in the storing unit becomes insufficient, the money handling apparatus cannot perform the dispensing process. Therefore, it is necessary to perform a money replenishment process before the money in the storing unit becomes insufficient. For example, Japanese Patent No. 5841897 discloses a money handling apparatus that automatically performs a replenishment process when the quantity of money in a storing unit becomes equal to or less than a predetermined quantity.

### SUMMARY OF THE INVENTION

In the conventional art described above, there is a problem that execution of other money handling is limited by the replenishment process. Even when money of a certain denomination becomes insufficient, if the amount of money of the certain denomination can be dispensed by using money of another denomination, there is no need to urgently perform the replenishment process. However, in the conventional art described above, the replenishment process is started when the quantity of money becomes equal to or less than a predetermined quantity regardless of denomination. The money handling apparatus does not perform a depositing process and a dispensing process while executing the replenishment process. For example, when the money handling apparatus, which is used for performing checkout for transaction with a customer in a store, starts the replenishment process during busy hours of the store, there is a possibility that many customers are made to wait.

The present invention has been made in view of the problem of the conventional art, and an object of the present invention is to provide a money handling apparatus that can change a condition for starting a money replenishment process.

A money handling apparatus according to one aspect of the claimed invention includes: a container removably mounted to the money handling apparatus and configured to store money of a plurality of denominations therein; a plurality of storing units configured to store therein money to be dispensed, for each denomination; a memory configured to store therein information on a threshold of a money quantity wherein the threshold is set for each denomination; and a control unit configured to perform control to monitor storage quantities of money for each denomination stored in the plurality of storing units, and to perform a replenishment process if a denomination of which the storage quantity becomes less than the threshold is detected, wherein in the replenishment process, money is fed out from the container and at least one storing unit corresponding to the detected denomination is replenished with money of the detected denomination among the fed out money.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for describing operation of a money handling apparatus according to an embodiment;

FIG. 2 is a cross-sectional schematic diagram schematically showing the internal structure of a coin handling apparatus;

FIG. 3 is a block diagram schematically showing the functional configuration of the coin handling apparatus;

FIGS. 4A to 4C are schematic diagrams for describing a depositing process, a dispensing process, and a replenishment process performed by the coin handling apparatus;

FIG. 5 illustrates an example of information managed by the coin handling apparatus to perform the replenishment process;

FIG. 6 illustrates an example of information on a cassette managed by the coin handling apparatus;

FIGS. 7A and 7B illustrate an example in which a replenishment start quantity and a replenishment quantity are set for each denomination;

FIGS. 8A and 8B illustrate an example of setting in which the replenishment start quantity and the replenishment quantity are changed in accordance with a condition;

FIG. 9 illustrates an example of a screen displayed on an operation/display unit in the case of manual setting; and

FIGS. 10A and 10B each illustrate an example of a notification screen.

### DESCRIPTION OF THE PREFERRED EMBODIMENTS

Hereinafter, an embodiment of a money handling apparatus according to the present invention will be described with reference to the accompanying drawings. The money handling apparatus according to the present invention can be used for various purposes in various places. In the present embodiment, the case where the money handling apparatus is installed in a store and used for checkout for transaction with a customer will be described as an example.

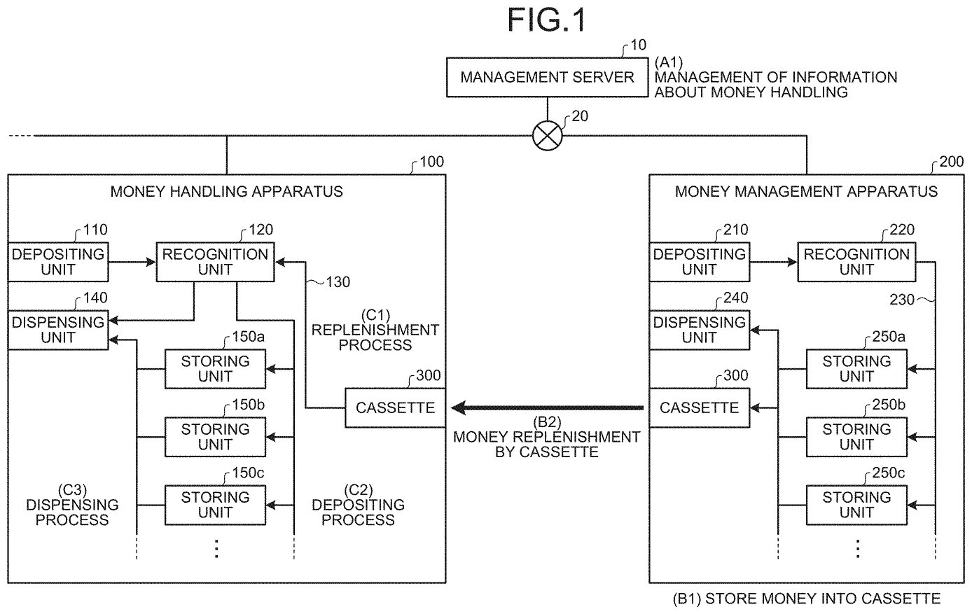

FIG. 1 is a schematic diagram for describing operation of a money handling apparatus 100 according to the present embodiment. As shown in FIG. 1, a management server 10, the money handling apparatus 100, and a money management apparatus 200 are communicably connected to each other via a network 20. The money handling apparatus 100 and the money management apparatus 200 are installed in a store. The installation place of the management server 10 is not particularly limited. The management server 10 may be installed in the store, or may be installed at another place outside the store.

FIG. 1 shows one money handling apparatus 100, but the number of money handling apparatuses 100 is not particularly limited. For example, a plurality of money handling apparatuses 100 installed in the same store are communicably connected to the management server 10 and the money management apparatus 200 via the network 20. For another example, a money handling apparatus 100 and a money management apparatus 200 are installed in each of a plurality of stores, and the money handling apparatuses 100 and money management apparatuses 200 of these stores are communicably connected to the management server 10 via the network 20.

The money handling apparatus 100 is installed at a checkout counter in the store and used for checkout. The money handling apparatus 100 performs a depositing process for depositing money received from a customer, and a dispensing process for dispensing change to be returned to the customer. In the depositing process, the money handling apparatus 100 receives money in a depositing unit 110, causes a recognition unit 120 to recognize and count the money, and stores the money in a plurality of storing units 150 (150a, 150b, 150c . . . ) for each denomination. The number of storing units 150 is not particularly limited. In the dispensing process, money of each denomination to be dispensed is fed out from the corresponding storing unit 150 and discharged to a dispensing unit 140. The movement of the money inside the apparatus is performed by a transport unit 130. The money is transported along a transport path connecting each unit. The money handling apparatus 100 manages the denomination of money and the quantity of money for each denomination being stored in each storing unit 150.

The money management apparatus 200 is installed in a back office in the store, for example. The money management apparatus 200 is used for managing money in the store. The money management apparatus 200 is a money handling apparatus that performs a depositing process and a dispensing process. For example, after the store is closed, the money management apparatus 200 performs a depositing process for depositing money collected from the money handling apparatus 100. For another example, before the store is opened, the money management apparatus 200 performs a dispensing process for dispensing money with which the money handling apparatus 100 is to be replenished. The money handling apparatus 100 is replenished with the dispensed money, and the money is used as change at the time of transaction with a customer.

In the depositing process, the money management apparatus 200 causes a recognition unit 220 to recognize and count money received in a depositing unit 210, and stores the money in a plurality of storing units 250 (250a, 250b, 250c . . . ) for each denomination. The number of storing units 250 is not particularly limited. In the dispensing process, money of each denomination to be dispensed is fed out from the corresponding storing unit 250, and discharged to a dispensing unit 240 or stored in a cassette (storage container) 300. Whether the money to be dispensed from the money management apparatus 200 is discharged to the dispensing unit 240 or stored in the cassette 300 can be selected when performing the dispensing process. The movement of the money inside the apparatus is performed by a transport unit 230. The money is transported along a transport path connecting each unit. The money management apparatus 200 manages the denomination of money and the quantity of money for each denomination being stored in each storing unit 250. The money management apparatus 200 also manages the denomination of money and the quantity of money for each denomination being stored in each storing unit 150 of the money handling apparatus 100.

The cassette 300 is a cassette-type container for storing money such that the money can be fed out therefrom. The cassette 300 can be mounted to each of the money handling apparatus 100 and the money management apparatus 200, and the mounted cassette 300 can be dismounted from each of the money handling apparatus 100 and the money management apparatus 200. The cassette 300 is used for carrying money between the money handling apparatus 100 and the money management apparatus 200. For example, in the dispensing process of the money management apparatus 200, the money dispensed from the storing unit 250 can be stored in the cassette 300. The cassette 300 in which money has been stored by the money management apparatus 200 can be dismounted from the money management apparatus 200 and mounted to the money handling apparatus 100.

The money handling apparatus 100 can acquire information on the denominations of money and the quantity of money for each denomination stored in the cassette 300 by the money management apparatus 200. For example, the money handling apparatus 100 acquires information on the money in the cassette 300 from the money management apparatus 200 via the network 20. For another example, the money management apparatus 200 writes information on the denominations of money and the quantity of money for each denomination stored in the cassette 300, in a memory disposed in the cassette 300, and the money handling apparatus 100 reads the memory and acquires the information. The money handling apparatus 100 can perform a replenishment process by using the money being stored in the cassette 300. The money handling apparatus 100 can manage the denominations of money and the quantity of money for each denomination being stored in the cassette 300.

As shown in FIG. 1, the management server 10 collects information regarding the contents of transaction performed with customers in the store, via the network 20, and manages the collected information (A1). The information collected by the management server 10 includes information on the depositing process and the dispensing process performed by each money handling apparatus 100 in each store. The management server 10 determines denominations of money and the quantity of money for each denomination to be prepared in the cassette 300 by the money management apparatus 200 in order to replenish the money handling apparatus 100 with the money. The denominations of money and the quantity of money for each denomination to be prepared in the cassette 300 can be determined based on information on the money that has been deposited and dispensed by the money handling apparatus 100 in the past, such that insufficiency of money does not occur again in the money handling apparatus 100 during opening hours of the store in that day.

For example, the management server 10 analyzes a plurality of pieces of information on the past depositing and dispensing performed in the money handling apparatus 100, based on date and/or day of the week. The management server 10 predicts denominations of money and the quantity of money for each denomination required by the money handling apparatus 100 during opening hours of that day based on result of the analysis and date and/or day of a week of that day. For example, if that day is a special sale day of the store, the management server 10 predicts denominations of money and the quantity of money for each denomination required by the money handling apparatus 100 during opening hours on that day, based on information on depositing and dispensing of past special sale days. For another example, the management server 10 predicts denominations of money and the quantity of money for each denomination required in the afternoon of that day, based on information on the quantity of money dispensed in the morning of the same day, etc. Information on the money predicted by the management server 10 is transmitted to the money management apparatus 200.

Before the store is opened, the money management apparatus 200 dispenses money, with which the money handling apparatus 100 is to be replenished, to store the money in the cassette 300 (B1). The money management apparatus 200 stores money predicted by the management server 10 to be required by the money handling apparatus 100 during opening hours in that day, in the cassette 300. Money to be stored as change fund in the storing units 150 of the money handling apparatus 100 before the store is opened, and money with which the storing units 150 are to be replenished after the store is opened, are stored in the cassette 300.

The cassette 300 in which large quantities of money of a plurality of denominations have been stored in a mixed state is dismounted from the money management apparatus 200 and mounted to the money handling apparatus 100 (B2). When the cassette 300 is mounted to the money handling apparatus 100, the money handling apparatus 100 acquires information of the denominations of the money and the quantity of the money for each denomination being stored in the cassette 300, and manages the information.

The money handling apparatus 100 performs a replenishment process in which the money is fed out from the cassette 300, recognized and counted by the recognition unit 120, and stored in the corresponding storing unit 150 (C1). Denominations of money and the quantity of money for each denomination to be stored in each storing unit 150 as change fund before the store is opened are set in advance. On the basis of the setting on the change fund, the money handling apparatus 100 feeds out a required quantity of money for each required denomination, from the cassette 300, and stores the fed out money in each storing unit 150. The store opens in a state where the set quantity of money as change fund is being stored in each storing unit 150.

After the store opened, the money handling apparatus 100 performs a depositing process for depositing money paid by a customer (C2) and a dispensing process for dispensing money to be returned as change to the customer (C3). When the quantity of money in the storing unit 150 decreases and reaches a replenishment start quantity that is a threshold set in advance, the money handling apparatus 100 automatically performs the replenishment process (C1). In the replenishment process, money of a denomination with which replenishment is to be performed is fed out from the cassette 300, and a preset quantity of the money fed out from the cassette 300 is stored in the storing unit 150.

The replenishment start quantity which is a threshold for determining whether or not the replenishment process is required can be set for each of the storing units 150. In the case where money is stored in the storing units 150 for each denomination, the replenishment start quantity is set for each denomination. The replenishment start quantity of each storing unit 150 can be set to any quantity smaller than the quantity of change fund that had been prepared therein before opening the store.

For example, the money handling apparatus 100 stores banknotes in four storing units 150a to 150d for each denomination, and a user sets a replenishment start quantity for the storing unit 150a for storing 1,000-JPY notes, to 100 banknotes, and sets a replenishment start quantity for the storing unit 150b for storing 5,000-JPY notes, to 50 banknotes. The money handling apparatus 100 monitors the number of banknotes being stored in each of the storing units 150a to 150d, and determines whether the number of banknotes becomes equal to or less than the replenishment start quantity each time the dispensing process is performed. Each time the number of 1,000-JPY notes stored in the storing unit 150a becomes equal to or less than 100, the money handling apparatus 100 performs the replenishment process, and stores the preset number of 1,000-JPY notes fed out from the cassette 300, in the storing unit 150a. Similarly, each time the number of 5,000-JPY notes stored in the storing unit 150b becomes equal to or less than 50, the storing unit 150b is replenished with the preset number of 5,000-JPY notes fed out from the cassette 300.

The replenishment start quantity can also be set for each denomination. The replenishment start quantity of each denomination can be set to any quantity smaller than the quantity of money of each denomination that had been prepared as change fund in the money handling apparatus 100 before opening the store.

For example, the money handling apparatus 100 has five storing units 150a to 150e, and the user sets a replenishment start quantity for 1,000-JPY notes to 300 banknotes, and sets a replenishment start quantity for 5,000-JPY notes to 200 banknotes, regardless of the storing units. The money handling apparatus 100 monitors the number of banknotes being stored in each of the storing units 150a to 150e, and determines whether the number of banknotes of each denomination becomes equal to or less than the replenishment start quantity each time the dispensing process is performed. For example, in the case where 1,000-JPY notes are stored in the two storing units 150a and 150b, the money handling apparatus 100 executes the replenishment process each time the total number of 1,000-JPY notes being stored in these two storing units 150a and 150b becomes equal to or less than 300. Similarly, in the case where 5,000-JPY notes are stored in the two storing units 150c and 150d, the replenishment process is performed each time the total number of 5,000-JPY notes being stored in these two storing units 150c and 150d becomes equal to or less than 200.

Similar to the replenishment start quantity, the replenishment quantity can be set for each storing unit, or can be set for each denomination. In the case where the replenishment quantity is set for each storing unit 150, in the replenishment process, the money handling apparatus 100 feeds out money in the replenishment quantity set for a storing unit 150 that is a target of the replenishment process, from the cassette 300, and stores the fed out money in the target storing unit 150. In the case where the replenishment quantity is set for each denomination, in the replenishment process, the money handling apparatus 100 feeds out money in the replenishment quantity set for the denomination that is a target of the replenishment process, from the cassette 300, and stores the fed out money in one or more storing units 150 corresponding to the target denomination.

The money handling apparatus 100 has a function of performing substitute dispensing. For example, when 5,000 JPY is to be dispensed, but the money handling apparatus 100 cannot dispense 5,000-JPY notes, the money handling apparatus 100 can perform the substitute dispensing in which five 1,000-yen notes are dispensed as substitute for one 5,000-JPY note. Therefore, a replenishment start quantity for a 5-based denomination can be set to a quantity smaller than a replenishment start quantity for a 1-based denomination that has a lower value than the 5-based denomination. Specifically, for example, the replenishment start quantity of 5000-JPY notes can be set smaller than that of 1,000-JPY notes whose value is lower than 5,000-JPY note. A replenishment quantity for a 5-based denomination can be set to a quantity smaller than a replenishment quantity for a 1-based denomination that has a lower value than the 5-based denomination. Specifically, for example, the replenishment quantity of 5000-JPY notes can be set smaller than that of 1,000-JPY notes whose value is lower than 5,000-JPY note.

In Japanese currency, 1-yen coins, 10-yen coins, 100-yen coins, 1,000-yen notes, and 10,000-yen notes correspond to 1-based denominations, and 5-yen coins, 50-yen coins, 500-yen coins, and 5,000-yen notes correspond to 5-based denominations. For example, if a replenishment start quantity for 1,000-yen notes is set to 100 banknotes, and a replenishment start quantity for 5,000-yen notes is set to 50 banknotes, the number of times of execution of the replenishment process can be reduced as compared to that in the case where the replenishment start quantity is uniformly set to 100 regardless of denomination. In addition, for example, if a replenishment quantity for 1,000-yen notes is set to 50 banknotes, and a replenishment quantity for 5,000-yen notes is set to 10 banknotes, the time required for the replenishment process can be shortened as compared to that in the case where the replenishment quantity is uniformly set to 50 regardless of denomination.

In US currency, 1-cent coins, 10-cent coins, 1-dollar coins, 1-dollar notes, 10-dollar notes, and 100-dollar notes correspond to 1-based denominations, and 5-cent coins, 50-cent coins, 5-dollar notes, and 50-dollar notes correspond to 5-based denominations. US 2-dollar notes and US 20-dollar notes are handled as 1-based denominations. In addition, US 25-cent coins are handled as a 5-based denomination. In Euro currency, 1-cent coins, 10-cent coins, 1-euro coins, 10-euro notes, and 100-euro notes correspond to 1-based denominations, and 5-cent coins, 50-cent coins, 5-euro notes, and 50-euro notes correspond to 5-based denominations. In Euro currency, 2-cent coins, 20-cent coins, and 2-euro notes are handled as 1-based denominations.

In the case where the money handling apparatus 100 handles foreign currency in addition to Japanese currency, the replenishment start quantity may be set for each storing unit or for each denomination such that a replenishment start quantity for a first denomination indicating a monetary amount of 10 to the power of n (n is an integer of 0 or more) is larger than a money replenishment start quantity for another denomination indicating a monetary amount higher than that of the first denomination and lower than a monetary amount of 10 to the power of (n+1). The replenishment quantity may be set for each storing unit or for each denomination such that a replenishment quantity for a first denomination indicating a monetary amount of 10 to the power of n (n is an integer of 0 or more) is larger than a replenishment quantity for a second denomination indicating a monetary amount higher than that of the first denomination and lower than a monetary amount of 10 to the power of (n+1).

For example, in the case where the money handling apparatus 100 handles US banknotes, a replenishment start quantity for 10-dollar notes (n=1) is set so as to be larger than each of replenishment start quantities for 20-dollar notes and 50-dollar notes each of which is more than 10 dollars and less than 100 dollars (n=2), in order to reduce the number of times of execution of the replenishment process. In in order to shorten the execution time of the replenishment process, the replenishment quantities for 20-dollar notes and 50-dollar notes are set so as to be smaller than the replenishment quantity for 10-dollar notes, for example.

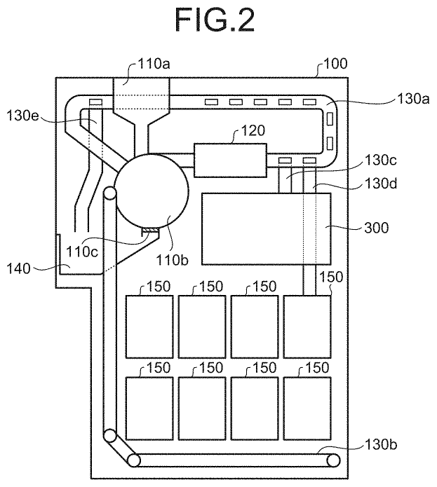

Next, the structure and operation of a specific money handling apparatus 100 will be described using a coin handling apparatus (money handling apparatus) 100 which handles coins, as an example. FIG. 2 is a cross-sectional schematic diagram schematically showing the internal structure of the coin handling apparatus 100. The depositing unit 110 of the coin handling apparatus 100 includes an inlet 110a in which coins are put, a feeding unit 110b which receives coins put in the inlet 110a and feeds out the coins to a transport path of an upper transport unit 130a, and a gate 110c through which coins in the feeding unit 110b can be discharged to the dispensing unit 140. The transport unit 130 includes the upper transport unit 130a and a lower transport unit 130b. The upper transport unit 130a transports coins fed out from the feeding unit 110b. The lower transport unit 130b receives coins fed out from the storing unit 150 and the cassette 300, and transports the received coins to the feeding unit 110b. The transport unit 130 includes a plurality of chutes 130c to 130e connected to the transport path of the upper transport unit 130a. The chute 130c connects the cassette 300 to the transport path. The chute 130d connects the storing unit 150 to the transport path in a one-to-one relationship. FIG. 2 shows one chute 130d, but the chute 130d is disposed so as to correspond to each of the storing units 150. The chute 130e connects the dispensing unit 140 to the transport path.

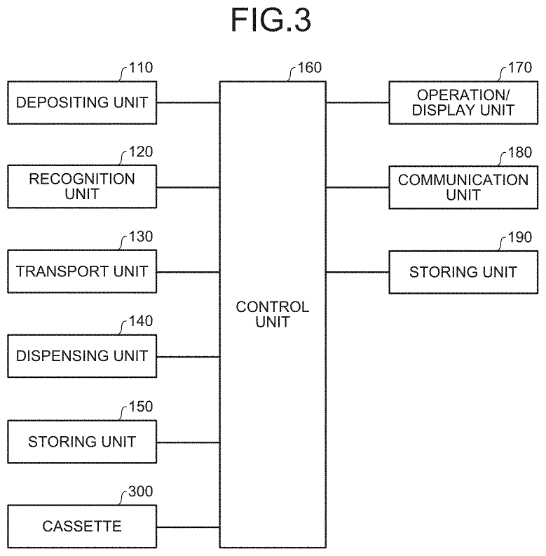

FIG. 3 is a block diagram schematically showing the functional configuration of the coin handling apparatus 100. In addition to the components shown in FIG. 2, the coin handling apparatus 100 includes a control unit 160, an operation/display unit 170, a communication unit 180, and a memory 190.

The communication unit 180 performs communication with an external apparatus. For example, the coin handling apparatus 100 can transmit information on the denomination of coins and the quantity of the coins for each denomination being stored in each storing unit 150, to the management server 10 and the money management apparatus 200 by using the communication unit 180. The coin handling apparatus 100 can receive information on the denominations of coins and the number of coins for each denomination stored in the cassette 300 by the money management apparatus 200, by using the communication unit 180.

The operation/display unit 170 is, for example, a touch panel type liquid crystal display device. The operation/display unit 170 functions as an operation unit for inputting information regarding money handling. Also, the operation/display unit 170 functions as a display unit that displays information regarding money handling.

The memory 190 is a nonvolatile storage device. Various kinds of information required for operation of the coin handling apparatus 100 is stored in the memory 190. For example, information on the denomination of coins and the number of coins for each denomination stored in each storing unit 150, and information on a replenishment start quantity and a replenishment quantity are stored in the memory 190.

The control unit 160 controls the function and operation of each component of the coin handling apparatus 100. The control unit 160 receives input of information through the operation/display unit 170. The control unit 160 outputs and displays information on the operation/display unit 170. The control unit 160 controls each component, while referring to various kinds of information stored in the memory 190, based on operations performed by using the operation/display unit 170 and information received by the communication unit 180, thereby realizing the functions and operations of the coin handling apparatus 100 described in the present embodiment.

The control unit 160 manages the denominations of coins and the number of coins for each denomination stored in the cassette 300, and the denomination of coins and the number of coins for each denomination stored in each storing unit 150. The control unit 160 monitors the storage quantities of coins currently stored in the cassette 300 based on the denominations of coins and the number of coins for each denomination stored in the cassette 300 when the cassette 300 is mounted to the money handling apparatus 100, the denominations of coins and the number of coins for each denomination fed out from the cassette 300 after the cassette 300 is mounted, and the denominations of coins and the number of coins for each denomination stored in the cassette 300 after the cassette 300 is mounted. Similarly, the control unit 160 monitors the storage quantity of coins currently stored in each storing unit 150 based on the denomination of coins and the number of coins for each denomination stored as change fund in each storing unit 150 before the store is opened, the denomination of coins and the number of coins for each denomination fed out from each storing unit 150 after the store is opened, and the denomination of coins and the number of coins for each denomination stored in each storing unit 150 after the store is opened.

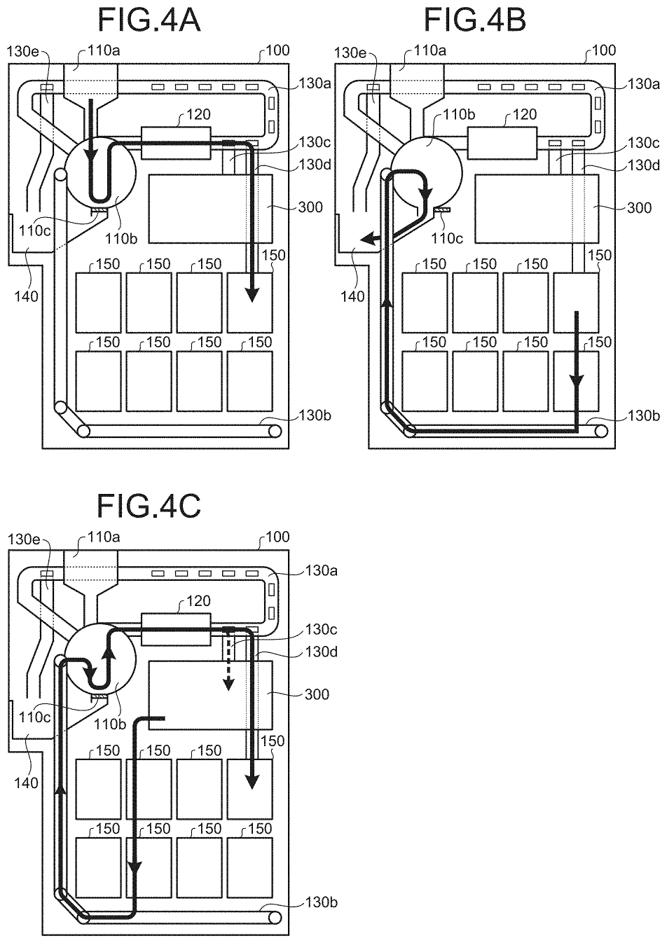

FIGS. 4A to 4C are schematic diagrams for describing a depositing process, a dispensing process, and a replenishment process performed by the coin handling apparatus 100. FIG. 4A illustrates the depositing process. As shown by an arrow in FIG. 4A, in the depositing process, a coin inserted in the inlet 110a drops in the feeding unit 110b. The feeding unit 110b can store therein a large number of coins and feed out the stored coins one by one. The coins fed out from the feeding unit 110b are transported one by one along the transport path by the upper transport unit 130a. The coins transported on the transport path are recognized and counted by the recognition unit 120. The coins are then dropped through the chute 130d, and are stored in the storing units 150 for each denomination. The arrow in FIG. 4A shows an example in which coins are stored in one storing unit 150, but the destination of each coin is determined in accordance with the denomination of the coin. Coins are stored in the storing units 150 for each denomination. Although not shown in FIG. 4A, if the coin cannot be stored in the storing unit 150 since the storing unit 150 is full with other coins, the coin drops through the chute 130c and is stored in the cassette 300. The denominations of coins and the number of coins for each denomination currently stored in the cassette 300, including coins stored in such a way, are managed in the money handling apparatus 100.

FIG. 4B illustrates the dispensing process. As shown by an arrow in FIG. 4B, in the dispensing process, coins to be dispensed are fed out from the storing unit 150 and dropped on a transport path of the lower transport unit 130b. The lower transport unit 130b transports the coins received on the transport path, to the feeding unit 110b in which the gate 110c is opened. The coins having dropped in the feeding unit 110b are discharged through the gate 110c to the dispensing unit 140. The arrow in FIG. 4B shows an example in which coins are dispensed from one storing unit 150, but coins corresponding to the number of coins to be dispensed are fed out from each of the storing units 150 corresponding to these coins, and discharged to the dispensing unit 140.

FIG. 4B illustrates an example in which the money handling apparatus 100 dispenses money without performing a recognition process by the recognition unit 120, but the recognition process may be performed in the dispensing process. In this case, coins to be dispensed are fed out from the storing unit 150 and transported by the lower transport unit 130b to the feeding unit 110b in which the gate 110c is closed. While receiving and storing the coins from the lower transport unit 130b, the feeding unit 110b feeds out the stored coins, one by one, to the transport path of the upper transport unit 130a. The fed-out coins are recognized and counted by the recognition unit 120. The coins are then dropped through the chute 130e, and are discharged to the dispensing unit 140.

FIG. 4C illustrates the replenishment process. As shown by a solid arrow in FIG. 4C, in the replenishment process, coins fed out from the cassette 300 drop on the transport path of the lower transport unit 130b. The lower transport unit 130b transports the coins received on the transport path, to the feeding unit 110b. While receiving and storing the coins from the lower transport unit 130b, the feeding unit 110b feeds out the stored coins, one by one, to the transport path of the upper transport unit 130a. The fed-out coins are recognized and counted by the recognition unit 120. Each of the coins is dropped through the corresponding chute 130d and stored in the corresponding storing unit 150, based on the recognition result. In the replenishment process, coins whose quantity equals to the replenishment quantity are stored in the storing unit 150 required to be replenished with the coins.

Coins of a plurality of different denominations are stored in a mixed state in the cassette 300. Therefore, there is a possibility that a coin of a denomination that is not a replenishment target is fed out from the cassette 300 during the replenishment process. If the denomination of a coin recognized by the recognition unit 120 is not a replenishment target, a method for handing this coin can be changed by setting. For example, as shown by a dashed arrow in FIG. 4C, a coin that is not a replenishment target drops through the chute 130c to be returned to the cassette 300.

For another example, a coin that is not a replenishment target is stored in the storing unit 150 corresponding to the coin. Even in this case, after the number of coins currently stored in the storing unit 150 reaches the number of coins set as the change fund, the coins are returned to the cassette 300.

For example, it is assumed that, a replenishment process for replenishing a first storing unit 150 for storing money of a denomination “A” with the money is started and the quantity of money being stored in a second storing unit 150 for storing money of a denomination “B” has not reached the replenishment start quantity but has decreased from the quantity of change fund set for the second storing unit 150. In this situation, if money fed out from the cassette 300 is money of the denomination A, the control unit 160 stores this money in the first storing unit 150. On the other hand, if money fed out from the cassette 300 is money of the denomination B, the control unit 160 stores this money in the second storing unit 150. The control unit 160 stores money of the denomination B fed out from the cassette 300 in the second storing unit 150 until the quantity of money being stored in the second storing unit 150 reaches the predetermined quantity of money that is set as change fund. After the storage quantity of the second storing unit 150 reaches the predetermined quantity of the change fund, the control unit 150 returns money of the denomination B fed out from the cassette 300 to the cassette 300. The storage quantity that is a threshold used by the control unit 160 to determine whether money of the denomination B is to be stored in the second storing unit 150 or returned to the cassette 300 can be changed by setting. Accordingly, even if the denomination of money fed out from the cassette 300 during the replenishment process is a denomination that is not a replenishment target, the fed out money can be used effectively.

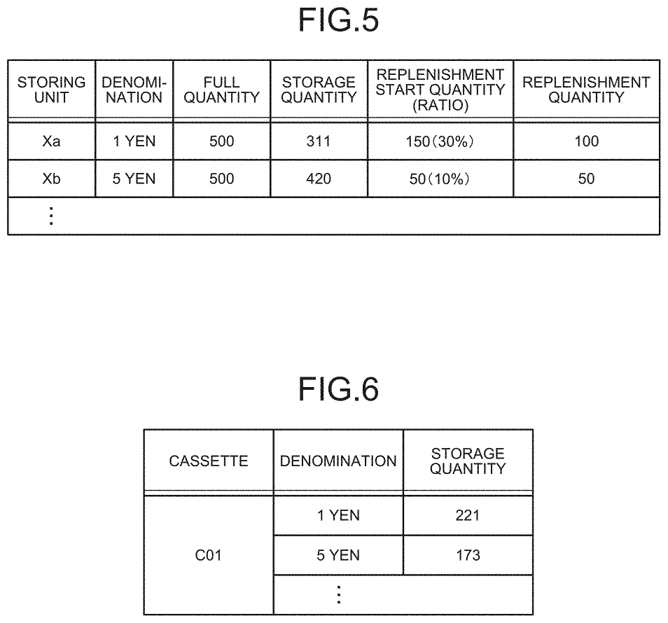

FIG. 5 illustrates an example of information managed by the coin handling apparatus 100 to perform the replenishment process. As shown in FIG. 5, for each of the storing units 150 (Xa, Xb . . . ), the control unit 160 of the coin handling apparatus 100 manages a denomination, a full quantity, a storage quantity, a replenishment start quantity, and a replenishment quantity, in the memory 190. The user of the coin handling apparatus 100 can change these setting by operating the operation/display unit 170.

The denomination shown in FIG. 5 indicates the denomination of coins to be stored in each storing unit 150. The full quantity of FIG. 5 indicates the maximum number of coins that can be stored in each storing unit 150. The storage quantity of FIG. 5 indicates the number of coins currently stored in each storing unit 150. The replenishment start quantity of FIG. 5 indicates a number of coins that is a threshold for starting the replenishment process. The replenishment quantity of FIG. 5 indicates the number of coins with which replenishment is performed when the replenishment process is performed.

The replenishment start quantity can be set by designating the quantity of money. Alternatively, the replenishment start quantity can be set by designating a ratio of the quantity of money to the full quantity. For example, when the maximum number of coins that can be stored in the storing unit 150 is 500 and the user wants to set 150 coins as the replenishment start quantity for this storing unit 150, the user can set the replenishment start quantity by designating the number “150” or by designating “30%”, by operating the operation/display unit 170.

FIG. 5 shows that 311 1-JPY coins are currently stored in the storing unit Xa which can store 500 1-JPY coins. If the storage quantity of the storing unit Xa becomes equal to or less than 150 coins that is 30% of the full quantity, the replenishment process is started and the storing unit Xa is replenished with 100 1-JPY coins. Meanwhile, FIG. 5 shows that 420 5-JPY coins are currently stored in the storing unit Xb which can store 500 5-JPY coins. If the storage quantity of the storing unit Xb becomes equal to or less than 50 coins that is 10% of the full quantity, the replenishment process is started and the storing unit Xb is replenished with 50 5-JPY coins.

FIG. 6 illustrates an example of information on the cassette 300 managed by the coin handling apparatus 100. The control unit 160 manages the denominations of coins and the number of coins for each denomination being stored in the cassette 300, in the memory 190. For example, when it becomes necessary to perform the replenishment process, but the coins in the cassette 300 are not enough for the replenishment quantity, the control unit 160 displays information to notify the user of this fact, on the operation/display unit 170, which will be described in detail later.

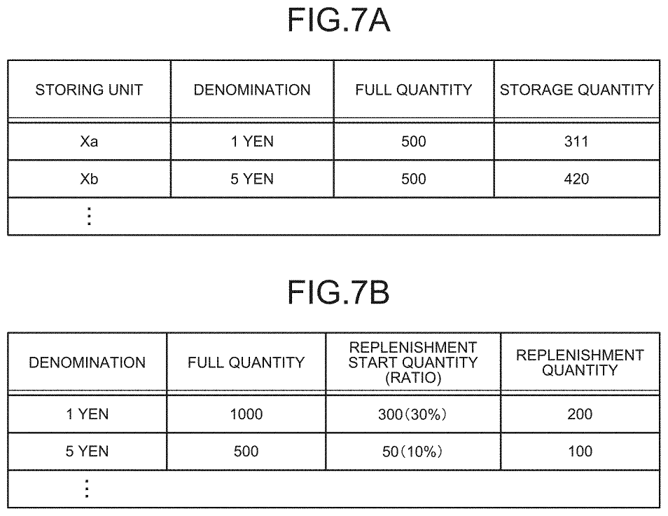

The user can set a replenishment start quantity and a replenishment quantity for each storing unit as shown in FIG. 5. Alternatively, the user can set a replenishment start quantity and a replenishment quantity for each denomination. FIGS. 7A and 7B illustrate an example in which a replenishment start quantity and a replenishment quantity are set for each denomination. The control unit 160 separately manages information on each storing unit 150 shown in FIG. 7A, and information on a replenishment start quantity and a replenishment quantity shown in FIG. 7B, in the memory 190.

Similar to FIG. 5, FIG. 7A shows that 311 1-JPY coins are being stored in the storing unit Xa which can store 500 1-JPY coins, and 420 5-JPY coins are being stored in the storing unit Xb which can store 500 5-JPY coins.

FIG. 7B shows a replenishment start quantity and a replenishment quantity that are set for each denomination with all the storing units 150 of the coin handling apparatus 100 as a target. For example, in the case where two storing units 150, each of which can store 500 coins, are allocated for storing of 1-JPY coins, a full quantity of 1-JPY coins that can be stored in the coin handling apparatus 100 becomes 1000 as shown in FIG. 7B. If the total number of 1-JPY coins in the two storing units 150 reaches 300 that is 30% of the full quantity, the replenishment process is started and the two storing units 150 are replenished with 200 1-JPY coins.

In the setting for each storing unit 150 shown in FIG. 5, if the number of 1-JPY coins stored in the storing unit Xa becomes equal to or less than 150, the replenishment process is performed. In the setting for each denomination shown in FIG. 7A, even when the number of coins stored in the storing unit Xa becomes equal to or less than 150, if the total number of 1-JPY coins being stored in the storing unit Xa and 1-JPY coins being stored in the other storing unit 150 has not become equal to or less than 300, the replenishment process is not performed.

It can be set that at least one of the replenishment start quantity and the replenishment quantity is changed in accordance with a condition. When the user sets a condition in advance, the control unit 160 changes at least one of the replenishment start quantity and the replenishment quantity in accordance with the condition. whether to automatically or manually perform the replenishment process can be selectable. A specific example of setting in which the replenishment start quantity and the replenishment quantity shown in FIG. 7B are changed in accordance with a condition will be described.

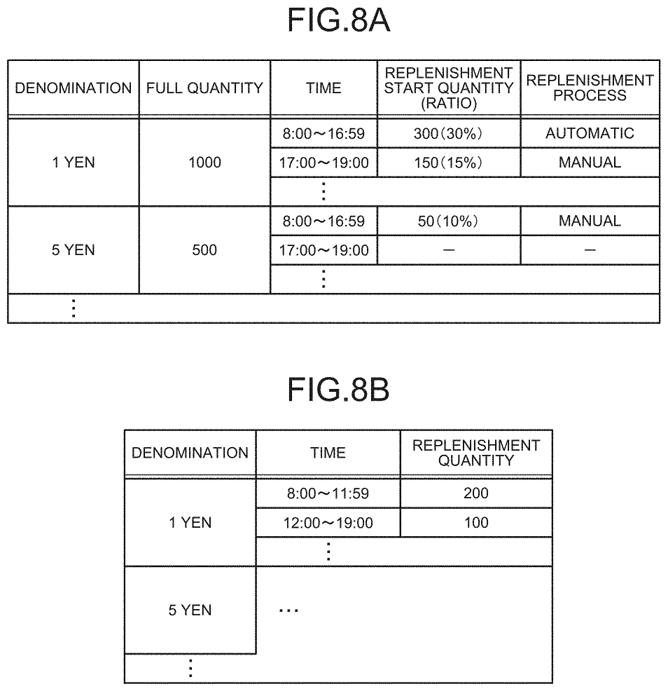

FIGS. 8A and 8B illustrate an example of setting in which the replenishment start quantity and the replenishment quantity are changed in accordance with a condition. FIG. 8A shows a condition of the replenishment start quantity of 1-JPY coins. If the time is from 8:00 to before 17:00, whether or not the replenishment process is required is determined with the replenishment start quantity as 300 coins. If the time is from 17:00 to 19:00, whether or not the replenishment process is required is determined with the replenishment start quantity as 150 coins.

FIG. 8B shows a condition of the replenishment quantity of 1-JPY coins. If the time is from 8:00 to before 12:00, the replenishment process is performed with the replenishment quantity as 200 coins. If the time is from 12:00 to 19:00, the replenishment process is performed with the replenishment quantity as 100 coins. In the example of FIGS. 8A and 8B, the replenishment start quantity is changed at 17:00, and the replenishment quantity is changed at 12:00, respectively. The coin handling apparatus 100 separately manages the replenishment start quantity and the replenishment quantity. The change condition for the replenishment start quantity and the change condition for the replenishment quantity can be set differently as described above.

FIG. 8A shows a condition of the replenishment start quantity of 5-JPY coins. If the time is from 8:00 to before 17:00, whether or not the replenishment process is required is determined with the replenishment start quantity as 50 coins. If the time is from 17:00 to before 19:00, the replenishment process is not performed. As described above, it can be set that the replenishment process is not performed based on a condition.

As shown in the items “replenishment process” in FIG. 8A, it can be set that the replenishment process is performed automatically or manually based on a condition. When “automatic” is set, the coin handling apparatus 100 automatically starts the replenishment process. When “manual” is set, the coin handling apparatus 100 displays information for the replenishment process on the screen of the operation/display unit 170 before starting the replenishment process.

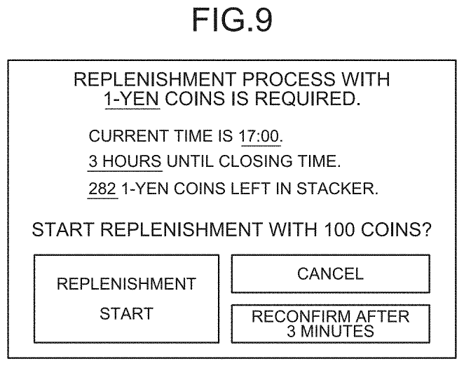

FIG. 9 illustrates an example of a screen displayed on the operation/display unit 170 in the case of manual setting. For example, when it becomes necessary to perform the replenishment process with 1-JPY coins between 17:00 and 19:00 for which start of the replenishment process is set as manual as shown in FIG. 8A, the screen shown in FIG. 9 is displayed.

As shown in FIG. 9, information on the denomination of coins with which replenishment is to be performed, information on the current time, information on the remaining time until the store is closed, information on the number of coins of the replenishment target denomination currently stored in the coin handling apparatus 100, and information on the replenishment quantity are displayed on the screen. The user can confirm the displayed information and choose to start the replenishment process, cancel the replenishment process, or reconsider about the replenishment process after a predetermined time period.

In the case of starting the replenishment process, the user operates the operation/display unit 170 to press a replenishment start button on the screen shown in FIG. 9. Upon receiving this operation, the control unit 160 starts the replenishment process. In the case of not performing the replenishment process, when the user presses a cancel button, the replenishment process is cancelled and is not performed. After the cancellation, the coin handling apparatus 100 returns to a state where the depositing process and the dispensing process can be performed.

In the case where the user desires to postpone the replenishment process or reconsider about the replenishment process later without immediately performing the replenishment process, the user presses a postponement button displayed as “reconfirm after 3 minutes” on the screen shown in FIG. 9. As a result, the replenishment process is not performed, and the user can use the coin handling apparatus 100 to perform the depositing process and the dispensing process. After 3 minutes from the time at which the postponement button was pressed, the control unit 160 displays again the screen shown in FIG. 9, on the operation/display unit 170. If the depositing process or the dispensing process is being performed after 3 minutes, the control unit 160 displays the screen shown in FIG. 9, on the operation/display unit 170 again after this ongoing process is completed. The user can reconsider whether or not to start the replenishment process and select execution, cancellation, or postponement of the replenishment process. The time for the postponement until the control unit 160 confirms again whether or not the replenishment process is required can be changed by setting.

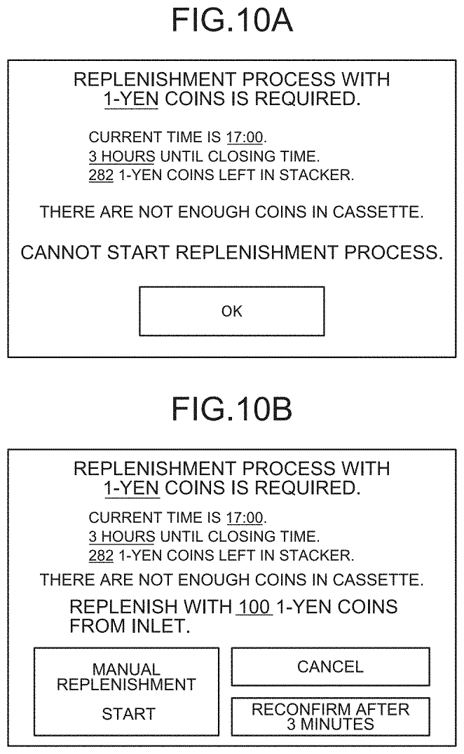

When it is necessary to perform the replenishment process, but the quantity of coins in the cassette 300 is smaller than the replenishment quantity, the control unit 160 displays information to notify the user of this fact, on the operation/display unit 170. FIGS. 10A and 10B each illustrate an example of a notification screen.

As shown in FIG. 10A, information on the denomination for which replenishment is required, information on the current time, information on the remaining time until the store is closed, and information on the number of coins of the replenishment target denomination currently stored in the coin handling apparatus 100 are displayed on the screen. In addition, information indicating that the replenishment process cannot be performed since the coins in the cassette 300 are insufficient is displayed on the screen. The user can confirm the notified information and handle this situation. When the user presses an OK button on the screen, the screen shown in FIG. 10A disappears, and the coin handling apparatus 100 returns to a state where the depositing process and the dispensing process can be performed.

The threshold used by the control unit 160 to determine whether insufficiency of coins in the cassette 300 can be changed by setting. The threshold can be set based on a replenishment quantity of coins with which replenishment is to be performed. For example, the user sets the threshold to be 50% of the replenishment quantity. In this case, for example, when it becomes necessary to perform the replenishment process with the replenishment quantity of 100 1-JPY coins, but the number of 1-JPY coins in the cassette 300 is less than 50 which is 50% of the replenishment quantity of 100 coins, the control unit 160 determines that coins for replenishment are insufficient and displays the screen shown in FIG. 10A, on the operation/display unit 170.

The threshold for determining insufficiency of coins in the cassette 300 can also be set based on the quantity of coins stored in the cassette 300. For example, the user sets the threshold to be 25% of the number of all coins being stored in the cassette 300. In this case, for example, when it becomes necessary to perform the replenishment process with 1-JPY coins, but the ratio of the number of 1-JPY coins to the total number of the coins in the cassette 300 is less than 25%, the control unit 160 determines that coins for replenishment are insufficient and displays the screen shown in FIG. 10A, on the operation/display unit 170. For example, when the total number of the coins being stored in the cassette 300 is 400 and the number of the 1-JPY coins among these coins is less than 100 which is 25% of the total number of 400, it is determined that the 1-JPY coins are insufficient for the replenishment process.

The cassette 300 stores coins of a plurality of denominations in a mixed state. If the ratio of the number of 1-JPY coins to the number of all the coins in the cassette 300 is small, there is a possibility that the number of times a coin of another denomination is fed out from the cassette 300 and stored in the storing unit 150 corresponding to the coin or returned to the cassette 300, is increased. As a result, a long time period may be required until the replenishment process is completed. It can be avoided that the replenishment process is performed over a long time period by setting that the replenishment process is not performed when the ratio of the number of coins of a denomination for replenishment to the total number of the coins in the cassette 300 has not reached a predetermined ratio.

In the case where the control unit 160 determines that the coins for replenishment in the cassette 300 are insufficient, it can be set that the user manually starts replenishment with coins. In this case, the control unit 160 that has determined that the coins for replenishment in the cassette 300 are insufficient displays information that promotes the user to perform manual replenishment with coins, on the operation/display unit 170 as shown in FIG. 10B, for example.

Information on the denomination of coins with which replenishment is to be performed, information on the current time, information on the remaining time until the store is closed, and information on the number of coins of the replenishment target denomination currently stored in the coin handling apparatus 100 are displayed on the screen shown in FIG. 10B. In addition, information that promotes the user to manually perform replenishment with coins and information on a replenishment quantity for the manual replenishment process are displayed on the screen.

The user can confirm the displayed information and choose to perform the manual replenishment process, cancel the manual replenishment process, or reconsider about the manual replenishment process after a predetermined time period. In the case of performing the replenishment process, when the user presses a manual replenishment start button on the screen shown in FIG. 10B, the control unit 160 starts the manual replenishment process. In this case, similar to the depositing process shown in FIG. 4A, the control unit 160 controls each component to perform a replenishment process such that coins inserted from the inlet 110a by the user for replenishment are recognized and counted, and then stored in the corresponding storing unit 150. In the case of not performing the replenishment process, when the user presses a cancel button on the screen shown in FIG. 10B, the replenishment process is cancelled and is not performed. In the case where the user desires to postpone the replenishment process or reconsider about the replenishment process later without immediately performing the replenishment process, when the user presses a postponement button displayed as “reconfirm after 3 minutes” on the screen, the replenishment process is not performed, and the user can use the money handling apparatus 100 to perform the depositing process and the dispensing process. After 3 minutes from the time at which the postponement button was pressed, the control unit 160 displays again the screen shown in FIG. 10B, on the operation/display unit 170. If the depositing process or the dispensing process is being performed after 3 minutes, the control unit 160 displays the screen shown in FIG. 10B, on the operation/display unit 170 again after this ongoing coin handling is completed. The user can select execution, cancellation, or postponement of the manual replenishment process on the screen displayed again. The time for the postponement until the control unit 160 confirms again whether or not start of the replenishment process is required can be changed by setting.

In the present embodiment, an example in which replenishment with money is performed by using the one cassette 300 is described, but a plurality of cassettes 300 may be used. In this case as well, a replenishment process can be performed by feeding out money from each cassette 300 as described above. The present embodiment is not limited to the mode in which money of a plurality of denominations is stored in a mixed state in the cassette 300. For example, money may be stored in a plurality of cassettes 300 for each denomination, or money of a plurality of denominations may be stored separately in one cassette 300 for each denomination and fed out for each denomination.

In the present embodiment, an example, in which the money management apparatus 200 stores in the cassette 300 the change fund and money required by the money handling apparatus 100 during opening hours of the store in one day, is described, but money to be stored in the cassette 300 is not limited thereto. For example, when the store is closed, change fund for the next day may be left in the storing units 150 of the money handling apparatus 100, and the rest of the money in the store may be collected. In this case, the money management apparatus 200 may store, in the cassette 300, money required for replenishing the money handling apparatus 100 during opening hours of the store in one day without storing the change fund therein. A method in which the denominations of money and the quantity of money for each denomination to be stored in the cassette 300 are determined based on the business of the day in the store is an example, and the denominations of money and the quantity of money for each denomination to be stored in the cassette 300 can be changed as appropriate. For example, denominations and the quantity of money for each denomination may be fixed, and money having the same breakdown may be stored in the cassette 300 each time.

In the present embodiment, an example in which the setting of the replenishment start quantity and the replenishment quantity is changed based on the time of day is described, but the condition for changing the setting of the replenishment start quantity and the replenishment quantity is not limited thereto. For example, only either the replenishment start quantity or the replenishment quantity may be changed. For another example, a change condition may be set by using at least one of time, day of the week, date, and month, and only at least one of the replenishment start quantity and the replenishment quantity may be changed based on the change condition. For example, if there is a denomination of which the quantity of dispensed money is significantly large during a predetermined time period, at least one of a replenishment start quantity and a replenishment quantity of this denomination is changed.

For example, in the case where the money handling apparatus 100 is connected to a cash register and used as a change machine, at least one of the replenishment start quantity and the replenishment quantity may be changed in accordance with a cashier who is in charge of the cash register. For example, when a replenishment start quantity and a replenishment quantity are set so as to be associated with identification information of each cashier, and the money handling apparatus 100 acquires identification information of a cashier from the cash register or the operation/display unit 170, at least one of the replenishment start quantity and the replenishment quantity may be changed in accordance with the cashier. For example, the replenishment start quantity is changed based on whether the cashier is a beginner or a skilled person. Accordingly, if the cashier is a skilled person, the number of times of execution of the replenishment process can be reduced as compared to the case where the cashier is a beginner.

For example, at least one of the replenishment start quantity and the replenishment quantity may be changed based on transition of a storage quantity of money. For example, it can be set that the control unit 160 changes at least one of the replenishment start quantity and the replenishment quantity based on a change in quantity of money stored during the day. Specifically, it can be set that at least one of the replenishment start quantity and the replenishment quantity is changed if the storage quantity of money of a certain denomination has decreased below a predetermined threshold within a preset time period. Alternatively, it can be set that at least one of the replenishment start quantity and the replenishment quantity for this denomination is changed if the storage quantity of money of a certain denomination does not decrease below a predetermined threshold within a preset time period. For example, at least one of the replenishment start quantity and the replenishment quantity for each denomination can be changed in accordance with whether the number of coins of each denomination has decreased below a threshold during the last one hour.

In the present embodiment, for easy understanding, the operation of each component has been described mainly with money quantities as an example, but the present embodiment is not limited to the mode in which money is managed based on money quantities. For example, money in each storing unit 150 may be managed based on a ratio of the quantity of money currently stored therein to the quantity of money that can be stored therein. Similarly, the replenishment start quantity and the replenishment quantity may be managed as ratios to the quantity of money that can be stored in the storing unit 150.

Specifically, in the case where the maximum storage quantity of the storing unit 150 is 500, management may be performed based on ratios to 500 such as a storage quantity of 300 is 60%, a replenishment start quantity of 100 is 20%, and a replenishment quantity of 50 is 10%.

In the present embodiment, the money handling apparatus is configured to include: a container removably mounted to the money handling apparatus and configured to store money of a plurality of denominations therein; a plurality of storing units configured to store therein money to be dispensed, for each denomination; a memory configured to store therein information on a threshold of a money storage quantity wherein the threshold is set for each denomination; and a control unit configured to perform control to monitor storage quantities of money for each denomination stored in the plurality of storing units, and to perform a replenishment process if a denomination of which the storage quantity becomes less than the threshold is detected, wherein in the replenishment process, money is fed out from the container, and at least one storing unit corresponding to the detected denomination is replenished with money of the detected denomination among the fed out money.

The money handling apparatus can monitor a storage quantity of money for each denomination stored in the plurality of storing units. If there is money of a denomination for which the storage quantity has reached the threshold, the money handling apparatus feeds out money from the storage cassette and replenishes the storing unit with fed out money. A user of the money handling apparatus can change a condition for starting the replenishment process by setting the threshold.

In the above configuration, the threshold is set for each of the plurality of storing units each of which stores money of different denomination, and the control unit performs the control to monitor the storage quantity of money in each storing unit, and to perform the replenishment process if a storing unit of which the storage quantity becomes less than the threshold is detected.

In the above configuration, the memory stores therein information on a replenishment quantity, with which replenishment is to be performed in one replenishment process, for each denomination, and in the replenishment process, the control unit performs control such that at least one storing unit is replenished with money corresponding to the replenishment quantity.

In the above configuration, the control unit changes at least one of the threshold and the replenishment quantity based on transition of a storage quantity of money for each denomination.

In the above configuration, the control unit changes at least one of the threshold and the replenishment quantity based on at least one of time, day of week, date, and month.

In the above configuration, the replenishment quantity is set such that the replenishment quantity for a 1-based denomination is larger than the replenishment quantity for a 5-based denomination.

In the above configuration, the threshold is set such that a threshold value for money of a 1-based denomination to start the replenishment process for the 1-based denomination is larger than a threshold value for money of a 5-based denomination to start the replenishment process for the 5-based denomination.

In the above configuration, the control unit monitors a storage quantity of money for each denomination stored in the container, and determines whether or not to perform the replenishment process based on the storage quantity of money in the container.

In the above configuration, after the container is mounted to the money handling apparatus, the control unit performs the control to monitor the storage quantity of money in the container, and to perform the replenishment process, and the replenishment process is performed a plurality of times until the storage cassette is dismounted from the money handling apparatus.

In the above configuration, the money handling apparatus further includes: a display unit configured to display information on the replenishment process; and an operation unit configured to receive an instruction to perform the replenishment process, and the control unit performs control such that the information on the replenishment process is displayed on the display unit before starting the replenishment process, and the replenishment process is performed on a condition that an instruction operation for the replenishment process is received through the operation unit.

In the above configuration, when an operation for postponing execution of the replenishment process is received through the operation unit, the control unit performs control such that the information on the replenishment process is displayed again on the display unit after elapse of a predetermined time period from the postponing operation, and the postponed replenishment process is performed on a condition that the instruction operation for the postponed instruction to perform the replenishment process is received through the operation unit.

As described above, in the money handling apparatus 100 according to the present embodiment, a replenishment start quantity can be set for each storing unit or for each denomination, as a condition for starting a money replenishment process. By changing a replenishment start quantity, which is a threshold for determining whether the replenishment process is required, for each storing unit or for each denomination, the number of times of execution of the replenishment process can be reduced as compared to the case where the replenishment start quantity is the same regardless of storing unit and denomination.

In the money handling apparatus 100, the quantity of money to be used for replenishment in the replenishment process can be set for each storing unit or for each denomination. By changing the replenishment quantity for each storing unit or for each denomination, the time required for the replenishment process can be shortened as compared to the case where the replenishment quantity is the same regardless of storing unit and denomination.

The money handling apparatus 100 performs the replenishment process by feeding out money from the cassette 300 and storing the money in the storing unit 150. In the case where the money handling apparatus 100 is used in a store, by storing money required during opening hours of the store in one day in the cassette 300 and mounting the cassette 300 to the money handling apparatus 100 before the store is opened, the money in the cassette 300 can be automatically stored in the storing units 150 during opening hours of the store. There is no need to prepare money for replenishment each time the replenishment process is required in the money handling apparatus 100, and thus the burden on the user is reduced.

As described above, the money handling apparatus according to the present invention is useful for changing a condition for starting a money replenishment process.

What is claimed is:

1. A money handling apparatus configured to dispense money, the money handling apparatus comprising:
a container removably mounted to the money handling apparatus and configured to store money of a plurality of denominations therein;
a plurality of storing units configured to store therein money to be dispensed, for each denomination;
a memory configured to store therein information on a threshold of a money storage quantity wherein the threshold is set for each denomination; and
a control unit configured to perform control to monitor storage quantities of money for each denomination stored in the plurality of storing units, and to perform a replenishment process if a denomination of which the storage quantity becomes less than the threshold is detected, wherein in the replenishment process, money is fed out from the container, and at least one storing unit corresponding to the detected denomination is replenished with money of the detected denomination among the fed out money.

2. The money handling apparatus according to claim 1, wherein
the threshold is set for each of the plurality of storing units each of which stores money of different denomination, and
the control unit performs the control to monitor the storage quantity of money in each storing unit, and to perform the replenishment process if a storing unit of which the storage quantity becomes less than the threshold is detected.

3. The money handling apparatus according to claim 1, wherein
the memory stores therein information on a replenishment quantity, with which replenishment is to be performed in one replenishment process, for each denomination, and
in the replenishment process, the control unit performs control such that at least one storing unit is replenished with money corresponding to the replenishment quantity.

4. The money handling apparatus according to claim 3, wherein the control unit changes at least one of the threshold and the replenishment quantity based on transition of a storage quantity of money for each denomination.

5. The money handling apparatus according to claim 3, wherein the control unit changes at least one of the threshold and the replenishment quantity based on at least one of time, day of week, date, and month.

6. The money handling apparatus according to claim 3, wherein the replenishment quantity is set such that the replenishment quantity for a 1-based denomination is larger than the replenishment quantity for a 5-based denomination.

7. The money handling apparatus according to claim 1, wherein the threshold is set such that a threshold value for money of a 1-based denomination is larger than a threshold value for money of a 5-based denomination.

8. The money handling apparatus according to claim 1, wherein the control unit monitors a storage quantity of money for each denomination stored in the container, and determines whether or not to perform the replenishment process based on the storage quantity of money in the container.

9. The money handling apparatus according to claim 1, wherein,
after the container is mounted to the money handling apparatus, the control unit performs the control to monitor the storage quantity of money in the container, and to perform the replenishment process, and
the replenishment process is performed a plurality of times until the container is dismounted from the money handling apparatus.

10. The money handling apparatus according to claim 1, further comprising:
a display unit configured to display information on the replenishment process; and
an operation unit configured to receive an instruction to perform the replenishment process, wherein
the control unit performs control such that the information on the replenishment process is displayed on the display unit before starting the replenishment process, and the replenishment process is performed on a condition that an instruction operation for the replenishment process is received through the operation unit.

11. The money handling apparatus according to claim 10, wherein
when an operation for postponing execution of the replenishment process is received through the operation unit,
the control unit performs control such that the information on the replenishment process is displayed again on the display unit after elapse of a predetermined time period from the postponing operation, and the postponed replenishment process is performed on a condition that the instruction operation for the postponed replenishment process is received through the operation unit.
